(19) United States
(12) Patent Application Publication
(10) Pub. No.: US 2004/0139661 A1
(43) Pub. Date: Jul. 22, 2004

(54) Profile in particular for refrigerator furniture units

(76) Inventor: Paolo Cittadini, Luvinate (IT)

Correspondence Address: Abelman Frayne & Schwab, 150 East 42nd Street, New York, NY, 10017-5612, US

(21) Appl. No.: 10/467,090

(22) PCT Filed: Jan. 23, 2002
(86) PCT No.: PCT/EP02/00669

(30) Foreign Application Priority Data
Feb. 2, 2001 (IT) MI2001A000201

(51) Int. Cl. A47B 96/04; E06B 7/16

(52) U.S. Cl. 49/489.1; 49/478.1; 312/406.2

(57) ABSTRACT

The present invention relates to an improved profile, in particular for refrigerator furniture units, of the type with a bellows seal which forms a sealed closure between the door and the furniture and able to allow automated assembly of the various components.

The patent application EP 9065464 in the name of the same Applicant describes a plastic profile for refrigerator furniture units and the like provided with door and an inner door, having a bellows seal portion which forms a sealed closure between the door and the furniture, the profile and the seal portion being joined together or integral as a single piece produced by means of coextrusion of two materials having a different rigidity so as to allow, if necessary, easy separation of the seal portion from the profile along their joining zone, said profile having a groove able to receive a replacement bellows seal portion, said groove being defined by a pair of walls which extend vertically or obliquely from a base formed with a substantially C-shaped cross-section comprising two horizontal upper and lower sections and being elastically deformable as a result of an elbow piece made of soft material and formed by means of coextrusion on the cross-section itself, this elbow piece therefore acting as a hinge so as to allow elastic splaying of said C-shaped cross-section so as to receive by means of snap-engagement the edge of said inner door inside the cross-section itself.

For the purposes of installation, the profile with the coextruded seal is advantageously provided in the form of a rectangular frame welded at the corners and then assembled together with inner door and door, as is for example described also in the European patents Nos. 146,994 and 319,087 in the name of the same Applicant.

More particularly, according to the patent application EP 905464, the profile with the seal is welded so as to form a rectangular frame which may thus be mounted on an inner door of the same shape, generally with perimetral dimensions 0.5-3 mm smaller than the internal dimension delimited by the vertical section of the base of the profile. This assembly is made possible by means of shearing of the lower horizontal section of said base, performed automatically during extrusion (or by acting on the end part of the ready-cut portions) to a depth of 3-5 mm and over the whole of its extension, thereby making it possible to avoid welding in the corners of this section.

Each section therefore is excluded from welding and can therefore be splayed independently, by means of its hinging point, through angles even greater than 90° so as to allow insertion of the inner door.

The operation of splaying of the abovementioned section is generally performed manually by acting on the lower section of all four sides of the frame through an angle sufficient for positioning of the inner door. Once this operation has been performed, the sections are released and the hinge causes them to snap-engage back into their initial position, locking the inner door in the C-shaped cross-section of the base of the profile.

The profile and the inner door thus assembled are then placed on the door and the whole assembly is fixed by introducing foam into the cavity between door and inner door.

According to the objects of the present invention, it is desirable that a profile of the type described above should be in particular suitable for automated assembly, without manual operations which slow down production considerably and obviously increase costs. However, with regard to the use of automated systems, it must be remembered that the profile, when it is inserted into the inner door, forms together with the latter an assembled system which must be able to withstand handling, including any sudden stresses imparted by the machinery, without causing any mutual displacement of profile and inner door.

The present invention relates to a profile of the kind described above, in particular suitable on the one hand for assembly on the inner door in an automated manner and on the other hand for solving the technical problem which rises in connection with the automated handling of the assembled parts, whereby mutual displacement of the said parts must be avoided at all costs. This refers in particular to the moment when inner door and profile in the form of a welded frame, once assembled, are gripped by suitable means, for example a suction pad which acts on the inner door, and are thus transported from the assembly station to the mould for filling the door/inner door system with foam. Since the foaming operation, namely filling of the cavity between door and inner door with a heat-insulating material such as polyurethane foam, would ‘freeze’ any defective positioning of the parts without the possibility for correction, any such defects must be carefully avoided so that correct fixing of profile and inner door during transportation to the foaming mould is not disturbed even in the case of sudden movements which may be imparted to the assembled parts by the system performing transportation from one station to another, and rapid, precise and safe operation is possible only when it is ensured that said parts remain in a fixed position, without mutual displacement.

The present invention proposes an improved profile of the abovementioned kind, suitable in particular for the solution of the technical problem described above. It consists of a plastic profile for refrigerator furniture units and the like provided with door and an inner door, having a bellows seal portion which forms a sealed closure between the door and the furniture, the profile and the seal portion being joined together or integral as a single piece produced by means of coextrusion of two materials having a different rigidity, said profile having a base formed with a substantially C-shaped cross-section comprising two horizontal upper and lower sections and being elastically deformable as a result of an elbow piece made of soft material and formed by means of coextrusion on the cross-section itself, this elbow piece therefore acting as a hinge for allowing elastic splaying of said C-shaped cross-section so as to receive by means of snap-engagement the edge of said inner door inside the cross-section itself, and externally and underneath said C-shaped cross-section the profile forming a seal on the edge of said door, characterized in that said lower section of said base is formed with a projection directed towards said upper section and able to engage operationally with a corresponding grooved seat formed on said inner door.

So that characteristic features and advantages of the invention may be better understood, a non-limiting example of embodiment thereof is described with reference to the figures of the accompanying drawings.

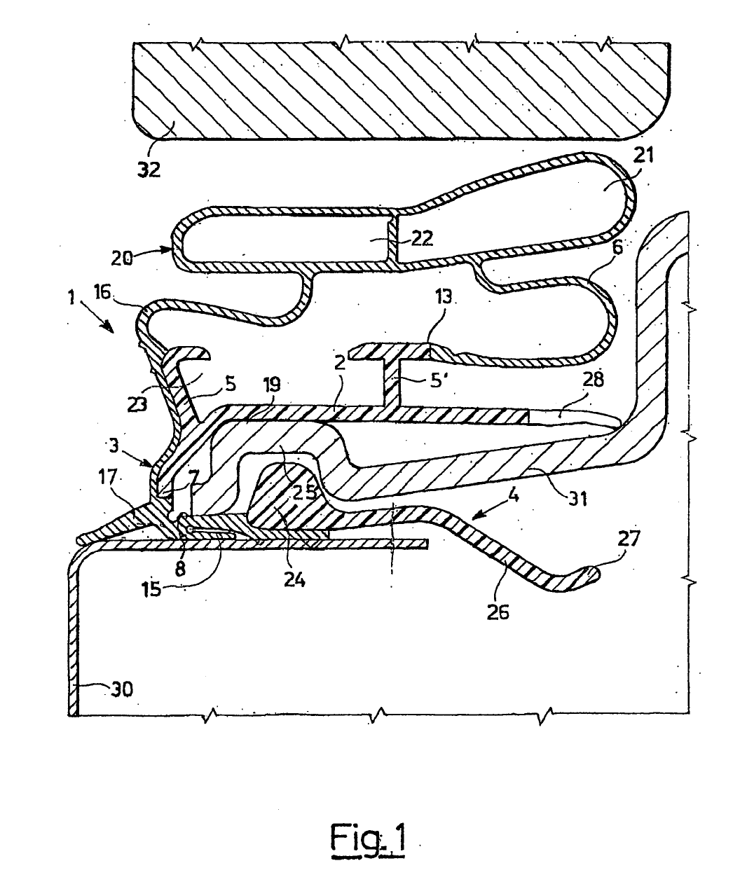

FIG. 1 shows a cross-sectional view of a profile according to the invention in an operative position;

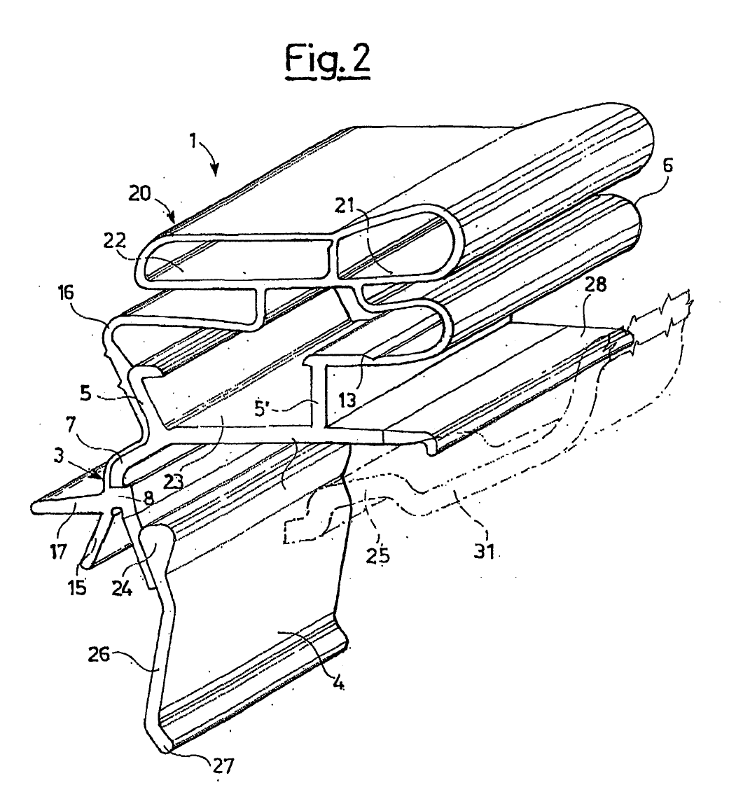

FIG. 2 shows a perspective view of a portion of the profile according to the invention during assembly on the inner door.

With reference to the drawing in FIG. 1, a plastic profile 1 for refrigerator furniture units provided with door 30 and inner door 31 has a bellows seal portion 20 which forms a sealed closure between door and the furniture 32 of the refrigerator.

The profile and the seal portion are joined together or integral as a single piece produced by means of coextrusion of two materials having a different rigidity so as to allow, if necessary, easy separation of the seal portion from the profile along their joining zone. This profile made of rigid material defines centrally a groove 23 able to receive a replacement bellows seal portion, this groove 23 being defined by a pair of walls 5, 5′ which extend vertically and obliquely from a base denoted overall by 3. According to the invention this base 3 is essentially formed with a C-shaped cross-section defined by two horizontal sections 2 and 4, i.e. an upper section and a lower section respectively, and a substantially vertical section 7 inside which a seat 19 is defined. Said vertical section 7 and said lower horizontal section 4 are joined together by an elbow-piece 8 made of soft material and formed by means of coextrusion on the cross-section itself with the rigid material which forms the base 3 of the profile, this elbow piece 8 acting as a hinging point for allowing elastic splaying of said C-shaped cross-section, in particular of the lower horizontal section 4 with respect to the sections 2 and 7.

The profile 1 is made of rigid plastic, for example PVC obtained by means of extrusion, cut and welded at the corners in the form of a frame which reproduces the perimeter of the door of the refrigerator furniture unit to which it is applied. As already mentioned, a seal 20, for example consisting of soft plasticized PVC, is also formed with the profile 1 by means of coextrusion as a single piece.

The seal 20 has a tubular section which defines an extendable chamber 21 acting as a bellows from where a seat 22 able to receive a bar of magnetic material extends. The internal side part, denoted by 6, of the seal 20 is welded to the corresponding wall 5′ of the profile at the coextrusion point 13, while the external side wall, denoted by 16, is integrally welded to the corresponding external wall 5 of the profile and along the outer side of the base 3.

The bottom shaped part of the external side wall 16 of the seal (wall which may be suitably varied in two zones having a different thickness or rigidity for ensuring the lateral stability thereof) covers fully the profile, terminating at the bottom in the said elbow-piece 8 defined above. A pair of sealing strips 15 and 17 also made of soft material extend laterally from the latter towards the outside of the profile, said strips resting in a compressed manner owing to the deformability of this material on the door 30 when the parts are assembled in the operative position, so as to form a seal and moreover ensure that the rigid portion of the profile 1 is fully concealed in this position.

In particular, these sealing strips constitute a seal for containing the foaming material which is used at the end in order to provide the door with heat-insulating properties after assembly of the parts. The strip 17 forms a seal with the metal plate of the door independently of its shape, since it is able to come into sealing abutment against it.

The upper section 2 of the base 3 of the profile also has a strip of coextruded soft material able to form a seal against the inner door in the final operative position.

According to the present invention, the lower section 4 of the base 3 is formed in the manner of a projection 24 directed towards the upper section 2 and able to engage operationally with a grooved seat 25 having a matching shape (in particular U shape) formed on the inner door 31 in the region of the edge of the latter. In order to be able to receive the edge of the inner door formed with this U-shaped groove, the interspace 10 in the C-shaped cross-section of the base 3 must be sufficiently wide and for this purpose the substantially vertical section 7 is at least partly directed obliquely.

In the example shown in the Figure, this projection 24 is formed at the end of the section 4 of the rigid base of the profile which is located close to the soft elbow piece 8, while at the opposite end the section 4 is formed with a section obliquely inclined downwards 26 and finally with an edge directed back upwards 27.

For the purpose of installation, the profile I with the coextruded seal 20 is advantageously provided in the form of a rectangular frame which is, welded at the corners and may thus be mounted on an inner door having the same shape in general with perimetral dimensions 0.5-3 mm smaller than the inner dimension delimited by the vertical section 7 of the base 3. This assembly is made possible by means of shearing of the horizontal section 4, performed automatically during extrusion (or by acting on the end part of the ready-cut portions) to a depth of 3-5 mm and over its whole extension, thereby making it possible to avoid welding in the corners of this section.

Each section 4 is therefore excluded from welding and can therefore be splayed independently and easily downwards, by means of the hinging point 8, through angles greater than 90° so as to allow insertion of the inner door 31, as shown in FIG. 2. The profile along the zone of welding (shown in view) with another portion of the profile is suitable for welding at any point, excluding the section 4 previously cut along 10. The edge of the inner door 31 may be advantageously prestressed in an elastic manner.

In a patent application filed simultaneously by the same applicant, a method and an apparatus able to perform in an automated manner the abovementioned assembly operations are described.

The operation of splaying of the section is performed with the aid of a machine provided with an automatic system (such as that described in the abovementioned simultaneous patent application in the name of the same applicant) which splays the lower section 4 on all four sides of the frame at an angle which is sufficient for positioning of the inner door, as schematically shown in FIG. 2. The above-described shaping of the section 4 in the oblique direction 26 and the end 27 facilitates engagement of the said splayable section by means envisaged for this purpose in the automatic apparatus. Once this operation has been performed, the sections 4 are released and the hinge 8 brings them back by means of snap-engagement into the position shown in FIG. 1, locking the inner door between the section 4 and the section 2 of the base of the profile. During its elastic return movement, the projection 24 of the section 4 is inserted by means of snap-engagement into the grooved seat 25 on the edge of the inner door. The projection 24 and the grooved seat 25 therefore constitute first and foremost a centring system during mutual positioning for assembly of profile and inner door.

In this position, shown in solid lines in FIG. 1, the lower sections 4 of the profile elastically act against the prestressed edge of the inner door 31. The engagement between the projection 24 on the profile and the corresponding grooved seat 25 formed on the inner door also ensures fixing of its parts along the whole perimeter of the inner door such as to ensure a stable connection, without the risk of mutual displacement even in the case of sudden stresses which may be imparted by the machinery.

The profile 1 and the inner door 31 thus assembled are then placed on the door 30 (for example by means of a robot system) and the assembly is fixed by filling the cavity between door and inner door with foam. In this final operative position, the profile forms a seal on the edge of the door 30 in the region of the sealing strips 15 and 17 and therefore underneath and externally with respect to said C-shaped cross-section.

The profile, when it is inserted on the inner door, forms therewith a single assembly which may be safely transported, being able to withstand also any sudden movements without causing separation, as a result of the interference between grooved seat 25 and projection 24.

A further advantage of the invention is that the interference between profile and inner door in the region of the coupling between projection 24 and seat 25 allows an additional sealing action preventing any foam from passing outside the door during the foam-filling stage.

Moreover the walls 5 and 5′ of the profile, which allow the engagement of a replacement seal if necessary, during the foam-filling operation limit compression of the profile and therefore allow a very small degree of deformation of the soft wall to be achieved.

The soft material coextruded on the outside of the profile avoids possible differences in colour between the rigid material and the soft material, and the substantially rigid structure of the profile prevents the profile itself flexing over partially on the horizontal sides owing to the weight of the magnetic insert.

1. Profile (1), made of substantially rigid plastic, for refrigerator furniture units and the like provided with door (30) and an inner door (31), having a bellows seal portion (20) which is made of substantially soft plastic and which forms a sealed closure between the door and the furniture (32), the profile and the seal portion being joined together or integral as a single piece produced by means of coextrusion of two materials having a different rigidity, said profile having a base (3) formed with a substantially C-shaped cross-section defined by two substantially horizontal sections, one upper (2) and one lower (4), and by a substantially vertical or oblique section (7), said section being elastically deformable as a result of an elbow piece (8) made of soft material and formed by means of coextrusion on the cross-section itself, this elbow piece therefore acting as a hinge for allowing elastic splaying of said section (4) of said C-shaped cross-section so as to receive by means of snap-engagement the edge of said inner door (31) inside (1 9) the cross-section itself, and externally and underneath said C-shaped cross-section the profile forming a seal on the edge of said door (30), characterized in that said lower section (4) of said base (3) is formed with a projection (24) directed towards said upper section (2) and able to engage operationally with a corresponding grooved seat (25) formed on said inner door (31).

2. Profile according to claim 1, characterized in that this projection (24) is formed at the end of the section (4) of the base (3) of the profile which is located in the vicinity of soft elbow piece (8), while at the opposite end the section (4) is formed first with a section obliquely inclined downwards (26) and finally with an edge directed back upwards (27).

3. Profile according to claim 1, characterized in that said section (7) of the base (3) is partly directed vertically and partly obliquely.

4. Profile according to claim 1, characterized in that a pair of sealing strips (15) made of soft material extend from said elbow piece (8) and in the operative position of the profile extend in the direction of the door so as to form a seal thereon.

5. Profile according to claim 1, characterized in that said seal is coextruded with said profile so as to be superimposed thereon over the whole length of the operationally external wall (5) of said pair of walls and on the portion—also external—of said base (3).

6. Profile according to claim 3, characterized in that said elbow piece (8) is formed integrally by the said seal portion which is superimposed externally on said profile and its base (3).

7. Profile according to claim 1, characterized in that a sealing strip (28) made of soft material extends from said upper section (2) of said base (3) in the direction of said inner door (31).

8. Frame formed by portions of profile according to the preceding claims, welded at the corners.
